(19) United States
(12) Patent Application Publication
(10) Pub. No.: US 2002/0152134 A1
(43) Pub. Date: Oct. 17, 2002

(54) System and method for protecting internet consumers and for certifying, identifying, segregating and locating traditional "brick and mortar" merchant businesses on the internet

(76) Inventor: Thomas A. McGlinn, Nokesville, VA (US)

Correspondence Address: HOGAN & HARTSON LLP, IP GROUP, COLUMBIA SQUARE, 555 THIRTEENTH STREET, N.W., WASHINGTON, DC, 20004, US

(21) Appl. No.: 10/120,411

(22) Filed: Apr. 12, 2002

Related U.S. Application Data
(60) Provisional application No. 60/283,147, filed on Apr. 12, 2001.

(51) Int. Cl. G06F 17/60

(52) U.S. Cl. 705/26

(57) ABSTRACT

A system and related methods for providing verifiable certification regarding the identity and legitimacy of the web sites of brick-and-mortar merchants are disclosed herein. The systems and related methods disclosed utilize a certification network that implements various computer and software implemented methods to help consumers, businesses and others to differentiate between the commercial Internet Web sites of traditional brick-and-mortar merchants and those web sites of less-trusted Internet-only enterprises. Merchants that meet a predetermined set of criteria representative of physical location, permanence, business practices and other indicia of overall consumer trustworthiness are certified by storing details of that certified merchant in a centralized merchant database in the certification network, granted a verifiable certification seal for display on their web site, and assigned a unique identifier. The predetermined set of criteria is measured by the completion of an on-site field survey at the merchant's traditional place of business, and upon the trusted third party's conclusion that the certification requirements have been met.

### RELATED APPLICATIONS

This application claims priority from co-pending and co-owned U.S. provisional patent application Ser. No. 60/283,147 filed Apr. 12, 2001, the specification of which is herein incorporated by reference in its entirety.

### FIELD OF THE INVENTION

The present invention disclosed herein relates to a system and method for providing various consumer protections by certifying the commercial Internet efforts of traditional merchant businesses. More particularly, the present invention provides trusted and verifiable certification by identifying and locating Web sites or other online or Internet representations of traditional “brick-and-mortar” merchant businesses.

### BACKGROUND OF THE INVENTION

For purposes of the forthcoming description of the present invention, a traditional merchant business is one that operates in a traditional commercial setting such as a real, physical, non-virtual, commercial merchant storefront where customers go to purchase goods. These entities are also frequently referred to as “brick-and-mortar” businesses by those skilled in the art of commerce over the Internet and World Wide Web (“Web”). Conversely, references herein to Internet-only merchants, commonly referred to in the art as “true-plays,” include those businesses that do not operate in a traditional merchant setting, such as with a physical storefront, such that customers may physically shop at the merchant's store.

The attraction of quick profits and low overhead costs has led to a proliferation of true-plays on the Web as Internet commerce has increased in popularity and acceptance among the public. The existence of these true-plays has made Internet commerce inherently different from traditional commerce.

In our real, non-virtual world, consumers, whether individuals or businesses, rely upon certain traditional, obvious, and trustworthy clues to determine what is or isn't a commercial establishment or traditional merchant business. One tends to recognize the merchant storefronts when driving past them, and one recognizes the likelihood of finding commercial areas within our community. Further, when consumers shop at the physical store of a merchant, they feel an implicit assurance of various inherent rights and consumer protections afforded by law with respect to traditional brick-and-mortar businesses.

Furthermore, when considering a purchase from anything less than an established merchant store, consumers often naturally develop a skepticism of the quality or authenticity of the goods being sold. Consequently, such purchases are either avoided or substantial cost reductions are sought due to the likelihood that the purchase may be from a merchant lacking a high level of knowledge regarding the goods, a dedication to customer service and satisfaction, and various protections such as insurance, warranties, etc. For example, when purchasing a sports watch from a sidewalk vendor on the street of a large city, a consumer often expects the goods to be of a lesser quality, and thus substantially cheaper than those sold in department stores. Consumers are therefore inherently provided with some degree of protection against fraud because in the traditional model of brick-and-mortar merchants, established and/or trustworthy merchants are easily identified and segregated from less established or trustworthy merchants.

Yet Internet commerce is attractive to traditional brick-and-mortar merchants as an additional means of exposure. Furthermore, the recent successes of many “click-and-mortar” enterprises (the Internet commerce Web site of a traditional merchant) by national chain merchants has proven that virtually shopping at a traditional merchant via Internet commerce can be attractive to consumers in matters of selection, economics and convenience. Unfortunately, the virtual realm of the Internet presently offers no such mechanism for clearly segregating the Web enterprises of traditional brick-and-mortar merchants from those of the population at large, including true-plays.

A clear detriment to consumers and traditional brick-and-mortar businesses operating on the Internet is that for little to no monetary expense, nearly anyone can prepare a collection of words and graphics to establish a digital mirage of a business on the Internet using practically any name. This being true, various trade experts and government agencies have been consistently reporting predictable rises in Internet-only business insolvency and/or customer dissatisfaction, as well as Web theft and fraud schemes. Nevertheless, industry trends and trade publications continue to indicate that conventional wisdom requires traditional brick-and-mortar merchants to establish a World Wide Web (“Web”) presence in order to compete with Internet-only merchants and enterprises less they see their market, and therefore profits, eroded.

Specifically, in establishing a Web presence, traditional brick-and-mortar merchants have benefited from a competitive advantage that is more likely to be present in the traditional merchant model when compared to the Internet-only merchant model. Particularly, traditional brick-and-mortar enterprises provide accessible customer service and a physical store location. Therefore, click-and-mortar enterprises can use their physical store location for customer service functions such as, for example, returning merchandise purchased over the Web. Importantly, the permanence associated with a physical business location known to the public also indicates to consumers a dedication to the business by its owners and instills a sense of confidence that is desired by consumers. For example, it is typically a concern among consumers that are considering making a purchase from an Internet-only enterprise that they will have little recourse to resolve problems after a sale if that merchant's Web site disappears (e.g., as would be the case if the merchant became insolvent or when the Web site is merely a temporary front for Internet fraud). Understandably, this creates various opportunities for consumer fraud. Recently, the FTC has reported that over 30% of their consumer complaints involve issues of Internet fraud and insolvency of companies represented by Internet-only endeavors.

Furthermore, even legitimate Internet-only merchants often pose problems for consumers. Often, true-plays are owned and operated by entrepreneurs that are pursuing retail efforts for the first time. As such, many start-up Internet-only merchants approach these efforts on a part-time basis without the adequate staff, knowledge and skill required and/or associated with a successful merchant. Unlike a traditional store, the consumer cannot simply take the purchased item back to the store and/or demand to speak to a manager immediately. Additionally, many true-plays are not factory-authorized sales representatives, and therefore warranty failures are beginning to be experienced by those consumers who have shopped using lowest price as the decided factor. Therefore the number of consumer complaints reported by the FTC regarding even legitimate Internet-only businesses also continues to rise.

In response to growing consumer and government concerns, various members of the Web-based commerce community have attempted to address mounting consumer fear and dissatisfaction related to online purchasing. Therefore, the certification of online merchants has been widely regarded and proposed as the best mechanism for protecting consumers from Internet fraud and thus boosting public confidence in online merchants. What such prior attempts to solve the problems that are particular to Web commerce have failed to recognize is that improved satisfaction and security can only begin to be achieved if commercial Internet enterprises are reasonably certain to be approachable and accessible whenever a consumer attempts to return a product or to obtain customer service. Therefore, it has become apparent to the Applicant that established and well known traditional brick-and-mortar merchants that venture onto the Internet and offer e-commerce Web sites in conjunction with their traditional stores are more likely to satisfy customers on the Internet when compared to many Internet-only endeavors.

Therefore, there remains a need in the art for a simple and efficient mechanism for commercial merchant efforts on the Internet to provide similar visible and verifiable assurances as have been traditionally associated with brick and mortar merchants.

### SUMMARY OF THE INVENTION

Accordingly, the present invention is directed to a system and method that compensates for the above-described shortcomings associated with Internet merchants by identifying and segregating Internet commerce enterprises of traditional brick-and-mortar merchants from those of Internet-only merchants.

It is therefore an object of the present invention to provide a system and method for reliably identifying and segregating brick-and-mortar merchants on the Internet through verifiable certification by a trusted third party.

Additionally, it is an object of the present invention to provide a system and method that certifies Internet merchants and provides those merchants with a unique, permanent identifier for use by consumers and other merchants on the Internet.

It is also an object of the present invention to provide a system and method for protecting consumers from electronic commerce fraud and boosting public confidence in online merchants by enabling Internet consumers upon request to review data regarding the business history, practices and activities of various certified merchants.

Further, it is an object of the present invention to provide a system and method that allows Internet consumers to identify trusted online merchants by a unique, permanent, and third party assigned identifier that can be used throughout the Internet in yellow page directories, search engines, secured merchant transactions and the like.

The above identified and other objects are achieved by the system and method for identifying and segregating Internet merchants according to the present invention. The invention's method and system provide a mechanism whereby a trusted third party provides a verifiable certification regarding the identity and legitimacy of the web sites of brick-and-mortar merchants, thus helping to alleviate the above-described and other consumer-encountered problems that are associated with Internet merchants and businesses. The present invention enables traditional brick-and-mortar merchant businesses to have their Web efforts verifiably certified by an independent trusted third-party, preferably electronically through an Internet-accessible certification network, that consumers, businesses and others can consult to verify the merchants location, certification, identification, and other relevant information as desired.

In segregating the commercial traditional merchant Web efforts from efforts of the Internet community at large, or particularly from Web efforts of Internet-only merchants or enterprises of those ordinarily thought of as consumers, the system and related methods of the present invention provides Internet consumers, “B2B” businesses and others with methods of identification, contact and other like assurances otherwise absent in the virtual realm of the Internet. The certification, through its ability to instill in the Internet community similar confidence and protection traditionally associated when conducting business with brick-and-mortar merchants, will benefit both brick-and-mortar merchants on the Web and Web consumers alike.

More particularly, the present invention pertains to a computerized system and related methods that enable Internet merchants to be certified by an independent third-party Web-based authority, or a certification network, that the Internet community can consult for the purposes of identifying, locating, linking to, contacting, gathering various information about, and learning various policies of traditional merchant businesses on the Internet. This includes the learning of important company contacts and information regarding the type of goods and/or services offered by the merchant's business.

Systems according to embodiments of the present invention utilize a certification network that implements various computer and software implemented methods to help consumers, businesses and others to differentiate between the commercial Internet Web sites of traditional brick-and-mortar merchants and those web sites of less-trusted Internet-only enterprises. Merchants that are deemed to have met a predetermined set of criteria representative of physical location, permanence, business practices and overall consumer trustworthiness are certified by storing details of that certified merchant in a centralized merchant database in the certification network, granted a verifiable certification seal for display on their web site, and assigned a unique identifier. The predetermined set of criteria is measured by the completion of an on-site field survey at the merchant's traditional place of business, and upon the trusted third party's conclusion that the program requirements have been met.

The disclosed related methods for identifying the electronic commerce Internet efforts of traditional merchant businesses are intended to be instituted in a computer environment using a certification network as a trusted third party and a verifiable source of merchant certification. The methods receive requests from merchants seeking certification as a traditional merchant business at the certification network and initiate a background check of each merchant. The background checks according to embodiments of the present invention include an on-site survey of the traditional commercial setting to determine whether a particular merchant qualifies for certification as an online merchant business that also operates in a non-virtual and traditional commercial setting as a brick-and-mortar business. For each successfully certified merchant, a unique identifier is assigned and stored in the certification network together with an electronically verifiable record of the certified merchant's activities as a brick-and-mortar merchant. Each record is made publicly accessible by the certification network and thereby provides electronically verifiable certification regarding each merchant that qualifies as being a traditional merchant business.

In various alternative yet preferred embodiments of the present invention as described herein, the centralized merchant database of information regarding the participating merchants utilized in systems and related methods according to the present invention can be utilized to provide various other beneficial services to both consumers and merchants. In certain of such embodiments, a centralized Web site can be hosted by the certification network and serve as an access point to information in the centralized merchant database, thus serving like an Internet directory of certified Web sites of brick-and-mortar merchants. In other such embodiments, the system and related methods according to the present invention assists in updating dead links (such as when a merchant changes its domain name) and thereby improves search engine productivity and accuracy. Similarly, in certain of said embodiments, the system and related methods can be adapted to provide dynamic “bookmarks” or “favorites” links to a Web consumers such that these consumers can easily find the web sites of their favorite click-and-mortar merchants on the Web without having to worry about changes in URL addresses of those merchants. Additionally, in yet other such embodiments, the system can provide consumers with a security checking process for any financial transactions undertaken with certified merchants. In this manner, the consumer can be assured that the merchant is using adequate security protocols before any confidential information (such as credit card numbers) is transferred over the Internet.

Additional features and advantages of the invention will be set forth in the description that follows, and in part will be apparent from the description, or may be learned by practice of the invention. The invention will now be described in further detail with respect to particular embodiments thereof with reference to the figures depicted in the appended drawings. The above and other objectives and advantages of the invention will be realized and attained by the embodiments particularly pointed out in the written description and claims hereof as well as the appended drawings. The following detailed description and figures are intended to be illustrative of particular applications of the inventive concepts and are in no way to be taken as limiting to the invention as claimed.

### BRIEF DESCRIPTION OF THE DRAWINGS

FIG. 1 is a schematic diagram that depicts how the certification network and method according to the present invention identifies and segregates Internet merchants that have a traditional brick-and-mortar presence from those Internet merchants that do not.

FIG. 2 is a flow diagram demonstrating a method for identifying and segregating Internet merchants according to embodiments of the present invention.

FIG. 3 is a flow diagram depicting a method employed to initiate the application review process according to preferred embodiments of the present invention.

FIG. 4 is a flow diagram depicting a method by which an on-site survey is initiated at a regional survey office according to preferred embodiments of the present invention.

FIG. 5 is a flow diagram depicting a method by which a surveyor completes an on-site survey according to preferred embodiments of the present invention.

FIG. 6 is a flow diagram depicting a method by which the results of an on-site survey performed by a regional search office is communicated to the certification network according to preferred embodiments of the present invention.

FIG. 7 is a flow diagram depicting a method by which a certification application and survey results are utilized by the certification network to complete the certification application process according to preferred embodiments of the present invention.

FIGS. 8a and 8b depict the top half and bottom half, respectively, of a web page display of a certification report window according to preferred embodiments of the present invention.

FIG. 9 is a logical diagram that schematically depicts how the unique certification identifier produced according to the present invention can be advantageously used in conjunction with business directories to locate desired merchants that have a brick-and-mortar presence.

### DESCRIPTION OF THE PREFERRED EMBODIMENTS

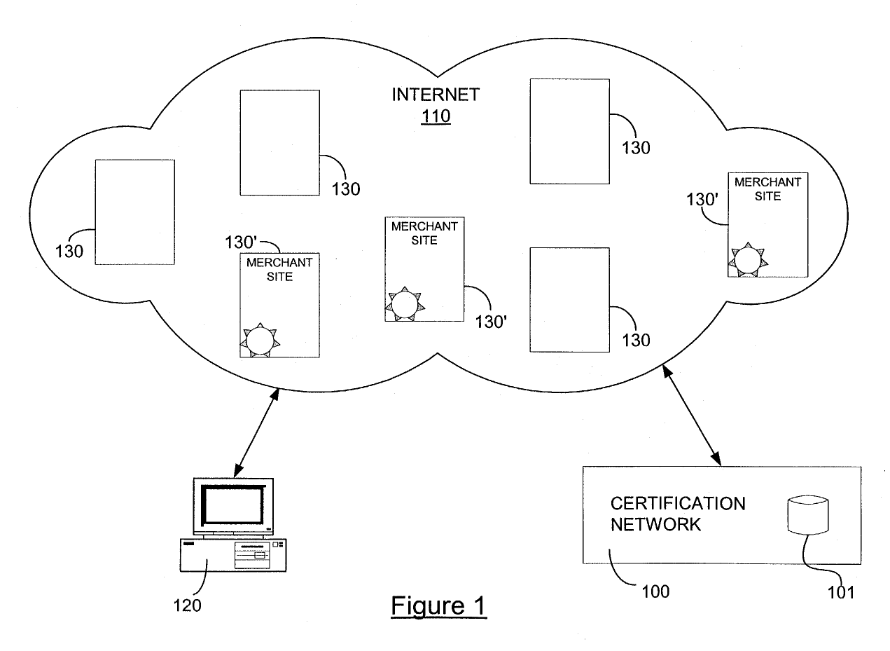

In embodiments of the certification systems of the present invention, as depicted in FIG. 1 a certification network 100 employs various computer and software implemented methods (as described functionally herein) that help consumers 120 (depicted as a Web-networked computer), businesses and others to differentiate between the commercial Internet Web sites 130′ of traditional brick-and-mortar merchants and those web sites 130 which are not commercial Internet web sites (and could be endeavors of less-trusted Internet-only enterprises or non-commercial web sites altogether). Merchants that are deemed to have met a predetermined set of criteria representative of physical location, permanence, business practices and overall consumer trustworthiness are certified by storing details of that certified merchant in a centralized merchant database 101 in the certification network 100, granted a verifiable certification seal for display on their web site and assigned a unique identifier. The predetermined set of criteria is measured by the completion of an on-site field survey, and upon the trusted third party's conclusion that the program requirements have been met. The survey is conducted at the merchant's place of business as such as in traditional commercial settings upon request by the merchant.

Embodiments of the present invention operate within a computerized system and employ related methods to enable Internet merchants to be certified by an independent third-party Web-based authority, or a certification network, that the Internet community can consult for the purposes of identifying, locating, linking to, contacting, gathering various information about, and learning various policies of traditional merchant businesses on the Internet. This includes the learning of important company contacts and information regarding the type of goods and/or services offered by the merchant's business.

As will be readily appreciated by one of ordinary skill in the art of commercial web page design and hosting, the certification network 100 according to embodiments of the present invention is comprised of suitable servers (including web servers, database servers, and other known computing devices), storage devices (including databases as herein described and other suitable storage means), memory devices, support hardware and operating software instructions as is known in the art to achieve the functions as herein described. It will, however, be readily appreciated by one of ordinary skill in the art that the functions of the related methods for the certification network herein described can be alternatively performed by a single computing device or by many computing devices in electronic communication with each other and the internet.

Preferably, participating merchants enter into a subscription for a certification service with the trusted third party that operates the certification network 100. This subscription may require a periodic renewal for the continued display of the merchant's certification seal. For the duration of the merchant agreement with the certification network, the merchant agrees to possible future, unannounced and random site survey visits to confirm that the information is still valid. Additionally, the merchant contractually agrees to inform the certification network of any changes to their information or location (such as changes in business/store address, Web page URL, or telephone number).

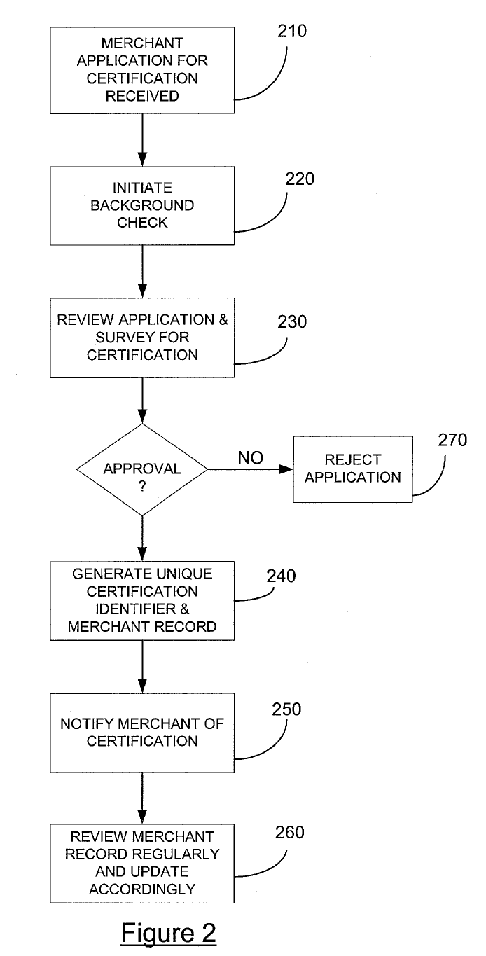

FIG. 2 generally depicts the steps whereby a click-and-mortar Web merchant can request certification by the certification network 100 and how the system and method of the present invention handles a request according to embodiments of the present invention. As shown in FIG. 2, the overall certification process begins with the certification network 100 receiving at step 210 an application for certification from an applicant merchant having an e-commerce web site. Preferably, the certification network supports a central web site wherein applicant merchants can submit certification applications electronically over the Internet such as via web forms, email or the like (alternatively, of course, traditional mechanisms such as telephone and postal mail can be used). Once the application is received, the network initiates at step 220 a background check of the applicant merchant which includes, as previously indicated, a on-site survey of the brick-and-mortar store site and/or business location of the applicant merchant.

After the background check and on-site survey are completed, the certification network reviews the application and survey at step 230 to determine if the application meets the standards for certification. In the event that any minimum standards are not met or by the applicant merchant or not proven satisfactorily by the application or the survey, the application is rejected at step 270.

In instances where a completed background check and survey indicates that the applicant merchant has proven that it meets all minimum certification standards, the certification network approves the application by generating a unique certification identifier and establishing a merchant record in the merchant database at step 240. The certified merchant is then notified (again, preferably via electronic mechanisms such as email) at step 250 of the approval of its application and its status as a certified merchant web site.

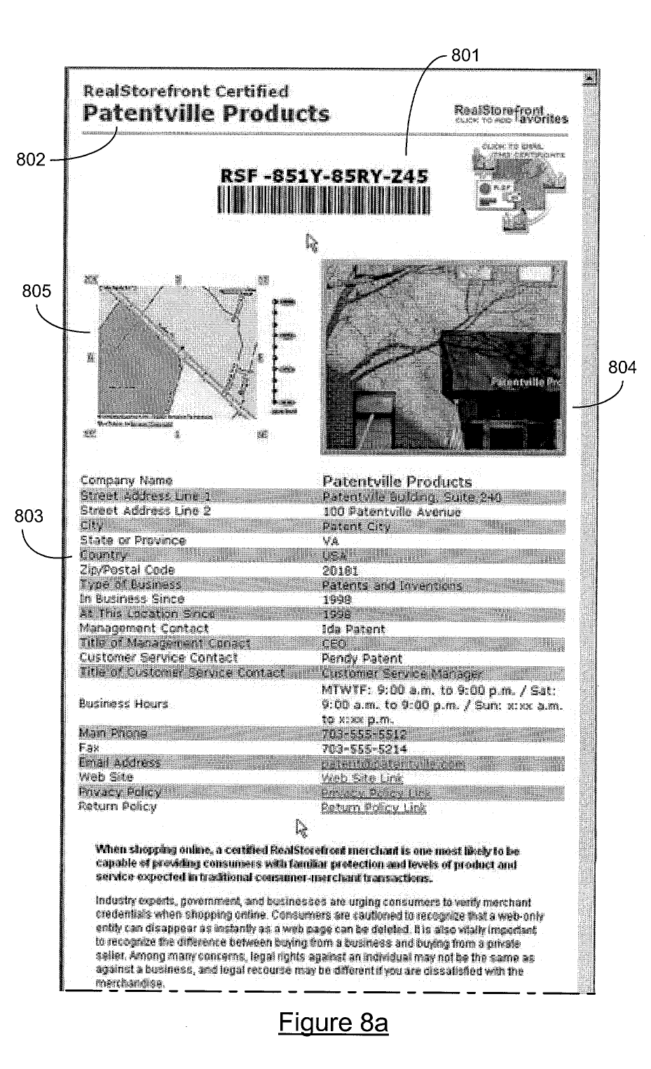

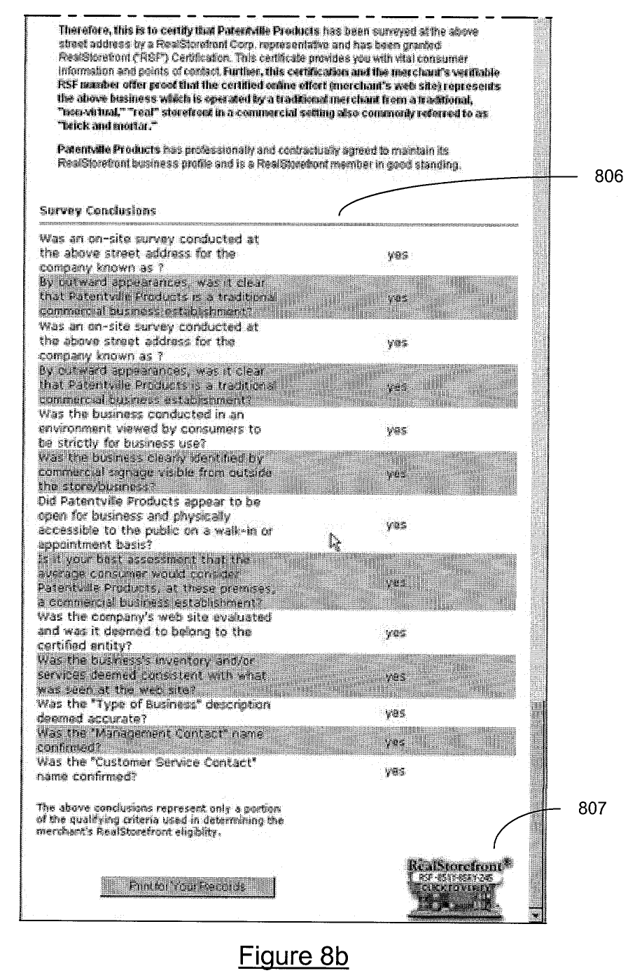

A certification seal is programmatically generated for each merchant that requests (and receives) certification from the trusted third party. Preferably, the seal integrates the unique certification identifier, such as an alpha-numeric string or serial number, that coincides with information relating to the merchant that is stored in centralized electronically accessible merchant database. The seal is displayed prominently on various pages of the merchant's Web site, and it provides click-through verification functionality, as depicted in FIG. 8 and described below, that leads an Internet visitor to information collected via the on-site survey process.

Also, as indicated above, a subscription requirement agreed to by a certified merchant would require the certified merchant to submit to possible future, unannounced and random on-site survey visits to confirm that the information in the certification database is still valid (i.e., that the merchant is still worthy of being certified and thus trusted by consumers). At step 260, therefore, the certification network reviews the merchant's database record regularly, initiates follow up on-surveys, and updates the merchant database record accordingly. Additionally, at step 260 the certification network updates the merchant records regarding any changed information regarding the merchant. In this manner, a merchant database that identifies and segregates Internet commerce enterprises of traditional brick-and-mortar merchants from those of less-trustworthy Internet-only merchants is obtained.

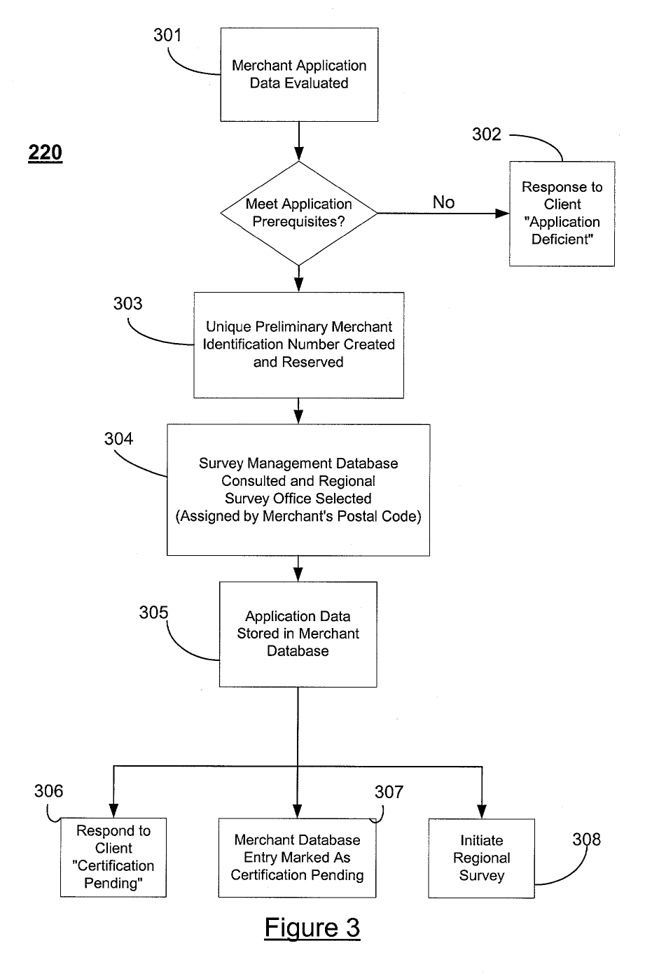

Referring now to FIG. 3, there is depicted the related method employed by the certification network 100 to initiate the application review process upon receiving a request from an interested applicant merchant according to preferred embodiments of the present invention. Initially, the application of the applicant merchant is evaluated 301 preliminarily to determine if it meets certain application prerequisites (such as the payment of an application fee or the adequate completion of certain fields in the application form). In the event that any prerequisite defects are found in the form of the certification application, an “Application Deficient” response is sent 302 to the applicant merchant detailing the nature of the deficiency and providing the applicant with instructions on how to cure the deficiency.

Those applications which meet all application prerequisites are accepted for review by the certification network and then a unique preliminary identifier, such as in the form of an alpha-numeric serial number, is created 303 and assigned to the applicant merchant and its entry in the merchant database. To begin the on-site survey process, the certification network next consults a survey management database and assigns 304 a nearby survey office (such as by nearest postal zip code) the task of performing the on-site survey to confirm that the online merchant is indeed a click-and-mortar merchant having a significant “real world” business. At this point, the applicant merchant's application data is stored 305 in certification network's merchant database along with a marking 307 of its status as a “Pending” certification. The applicant merchant is then provided with a “Certification Pending” communication at 306 and the on-site survey process is initiated 308.

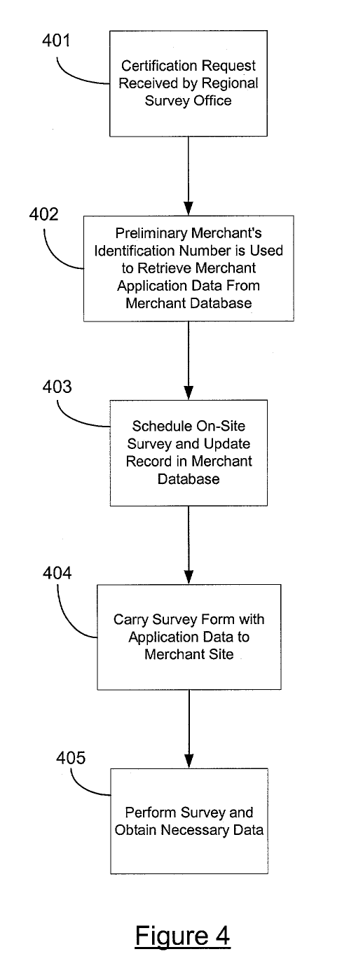

As shown in FIGS. 4, 5 and 6, the on-site survey process utilized in preferred embodiments of the present invention is performed via a network of regional survey offices and/or field surveyors who travel to the merchant's place of business to secure and confirm the information necessary for certification. Preferably, this information includes a picture of the storefront and signage for the merchant in its commercial setting (see FIG. 8 and accompanying description below). This information helps convey a degree of permanence to a Web consumer that can be equated with relative trustworthiness. Additionally, other survey information that can be collected includes a description of inventory, which is examined to confirm that it is consistent with that sold by the type of business represented by the Web site, a description as to how long the merchant has been located at a particular location, and a description as to how long the business has been in existence, links to its Web site, its return and privacy policy, whether the merchant is an authorized retailer and/or distributor of particular goods, the level of and/or acceptability of the online security protocols used in secure financial Web transactions by the merchant and other such information.

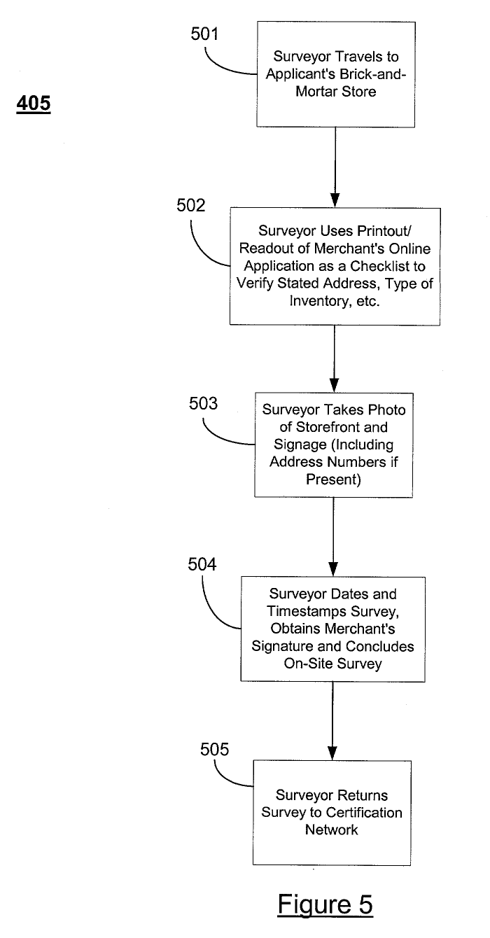

In one preferred implementation of the present invention, the method by which an on-site survey is initiated at a regional survey office is performed as generally depicted in FIG. 4. Specifically, the initiation of the on-site survey may begin when a certification request regarding the applicant merchant is received by a regional survey office at step 401. Preferably, this request is received electronically and generated automatically by the certification network as described above. Then, in step 402 the regional survey office use the preliminary merchant's identification number to retrieve necessary merchant application data (such as location, contact information, and hours of operation) from the merchant database. The regional survey office then schedules an on-site survey and updates records in the merchant database (to reflect the scheduled survey) at step 403. The surveyor then carries a survey form specifically detailing the desired application data to the requesting merchant's site at step 404. Alternatively, the survey form may be forwarded to the requesting merchant using known communication or transportation techniques including, but not limited to, mail, e-mail, telephone, facsimile, telex, couriers, FTP, etc. Preferably, the survey form is carried by the surveyor in electronic format, such as on a PDA or other portable digital computing device such that the survey results can be immediately entered into electronic format and therefore more easily transmitted to the certification network upon completion. Subsequently, the surveyor performs the survey and obtains the necessary data at step 405 which is disclosed in more detail below with respect to FIG. 5.

Additionally, in this particular preferred embodiment of the invention the performance of the survey and obtaining of the necessary data in step 405 is performed as depicted in FIG. 5. Specifically, FIG. 5 depicts a method by which a surveyor completes an on-site survey. First, in step 501, the surveyor travels to the merchant applicant's on-site location, or brick-and-mortar store as detailed in the application data. At the store, the surveyor may use a printout or readout of the merchant's previously submitted online application as a checklist of the stated address, type of business and inventory, etc. in step 502 to make certain that all the necessary requisites for certification are considered. Most preferably, as described above, the surveyor uses a portable electronic computing device to perform the survey where the device provides and electronic checklist that asks appropriate questions and prompts appropriate inquiries based upon the merchant's application and the survey results entered.

Additionally, the surveyor in step 503 takes one or more photographs (preferably with a digital camera) of the storefront and signage that preferably include indications of the address, condition and type of business of the merchant's store, etc. After completing the survey form and taking the necessary photographs, the surveyor dates and timestamps the survey form and concludes the on-site site survey at step 504. In this step, the surveyor may further obtain the merchant's signature. After concluding the on-site survey, the surveyor returns the survey form containing the results to the certification network at step 505.

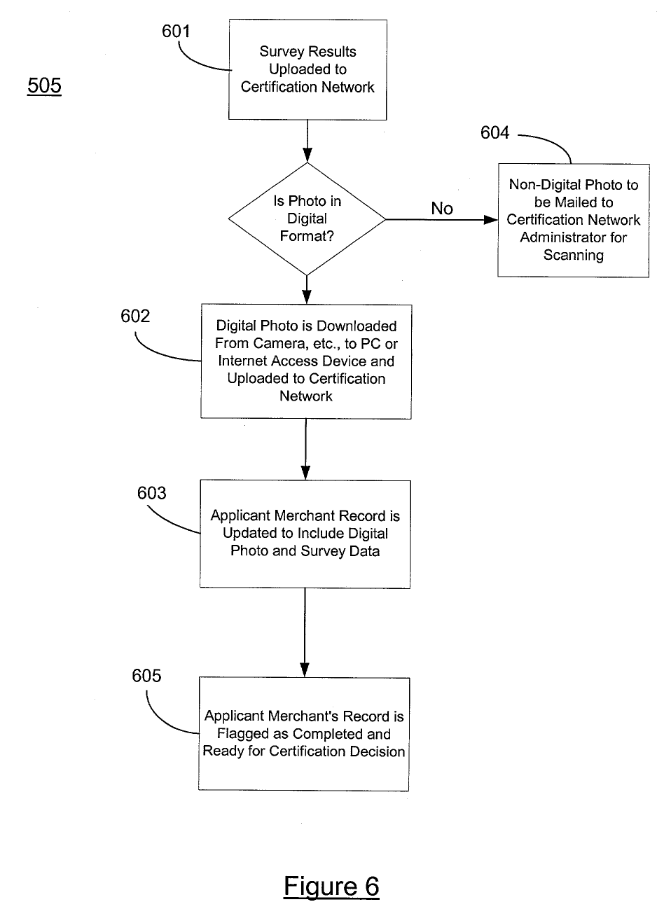

Upon returning to the regional survey office, the results of an on-site survey performed by the surveyor may be communicated to the certification network, step 505 discussed generally above with respect to FIG. 5, as generally depicted in FIG. 6 in preferred embodiments of the present invention. The results from the survey are uploaded to the certification network in step 601 using known techniques and protocols according to the technology used by the certification network. The photograph(s) of the merchant's storefront may also be uploaded to the certification network. Preferably, the photograph is taken with a digital camera to expedite the certification process. For instance, the surveyor may use a digital camera to photograph the storefront as opposed to using a non-digital photograph that must be then scanned and converted to a digital format using known technology. If the photograph is in a digital format, the digital photograph is downloaded to a computer or Internet access device and uploaded to the certification network, step 602. Obviously, surveyor may use any other known techniques to connect and transfer the survey data to the certification network. At this point, the applicant merchant record is updated to include the digital photograph and survey data, step 603. Alternatively, if the survey photograph is not in a digital format, the surveyor may forward the photograph (or copy thereof) to the certification network step 604. For instance, the surveyor may forward the photograph through the mail or electronic data transport techniques such as a facsimile. Finally, at step 605 the applicant merchant record is flagged as completed and ready for a certification decision as described in other portions of this application.

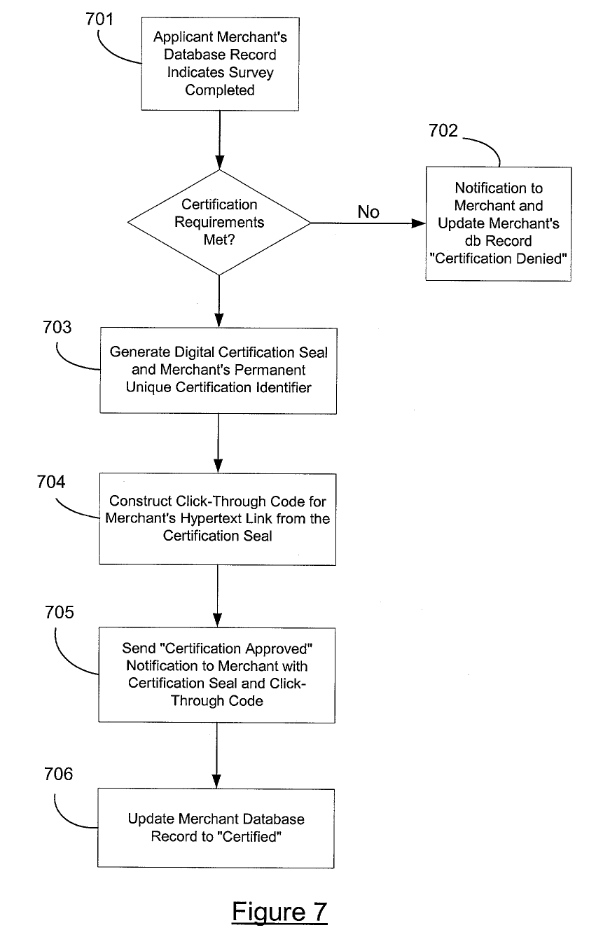

Referring now to FIG. 7, there is depicted a method according to preferred embodiments of the present invention by which the data of a certification application and final on-site survey results are utilized by the certification network to complete the certification application process. The use of the certification application and survey results by the certification network to complete the certification application process begins with the completion of the survey at step 701. More specifically, in step 701, the applicant merchant data record should indicate that the survey is completed, as described above in step 605. The database survey records may now be used to determine if the merchant meets certification requirements. The merchant records are evaluated according to various needs and requirements for certification. Where the merchant fails certification requirements as described generally above, a notification of the failure may be forwarded to the merchant and the merchant's database record is updated to reflect denial of certification, step 702.

Continuing with FIG. 7, if the merchant meets the certification requirements, the certification network generates a digital certification seal and a permanent, unique certification merchant identifier (or equivalent thereof), step 703. Then, in step 704, the certification network further constructs a click-through code for the merchant's hypertext link from the certification seal created in step 703. At the point, the certification network may send notification to the merchant of the certification approval, along with the certification seal and the click-through-code, step 704. In addition, the merchant database is updated to include some type of indication that the merchant has been certified, step 705.

As described herein, a Web consumer may arrive at a the web site of a brick-and-mortar merchant certified according to the present invention web site a number of ways including directly through the use of the appropriate URL, indirectly through a listing provided by the central web site hosted by the certification network, Internet search engine queries, search engine queries adapted to return results containing only certified merchants, and through dynamic unique identifier URLs.

Regardless of the manner of arrival, a web consumer visiting at web site of a certified merchant may elect merely to note the presence of the certification seal to confirm that the business is not just a true-play endeavor of sham web site. However, more complete verification is immediately available by clicking the certification seal, which presents the visitor with a separate window (created through web site scripting techniques as are known in the art) containing the merchant's certification status, descriptive data and other information secured during the certification process and on-site surveys as described above which are securely stored in the merchant database of the certification network.

FIGS. 8a and 8b depicts a web page display of a certification report pop up window as it appears when the certification seal is clicked on in the Internet browser of a Web consumer according to preferred embodiments of the present invention. As depicted in FIG. 8a the pop up certification window provides unique identification and proof through various types of information that the certified online effort (merchant's web site) represents a business operated by a traditional merchant. The certification record display of “Patentville Products” as depicted in FIGS. 8a and 8b prominently displays the merchant's name 802 and the unique identifier in the form an alpha-numeric serial number 802 at the top of the certification record window. Also near the top of the certification record window is presented the demographic information regarding the merchant 803, including its street address, type of business, year of establishment, years at the current address, hours of operation, customer representative contact, phone and facsimile numbers, email addresses, web site URL. As shown in FIG. 8a, the certification record window can contain a hyperlink to the certified merchant's website as well as to a copy of the merchant's privacy and return policies. Additionally, the record contains a photograph 804 of the outside of the merchant's site, preferably including the signage of the merchant, and a map 805 demonstrating how to get to the merchant site from major roads or intersections. Referring specifically now to FIG. 8b, which depicts the bottom half of the web page display, there is displayed a listing of the conclusions obtained during the on-site survey.

At the bottom of the web page is depicted a certification seal 807 according to preferred embodiments of the invention. Certification seal 807 is the same design certification seal that is distributed to certified merchants. In preferred embodiments of the invention, the certification seals given to each certified merchant will appear basically the same except that each certification seal will incorporate the unique identifier assigned to that particular merchant digitally into the seal design as is depicted.

As illustrated by the particular embodiments described above, it is apparent that the present invention changes the Internet in a dramatic way. It provides a good measure of consumer protection by allowing consumers to know they are dealing with real, traditional merchant business, and accordingly they are afforded various protections, legal or otherwise, to which they otherwise may not be entitled. The product allows the consumer to know more about the business by providing information about the business, its management, its location, its return and privacy policies, etc. These items will-be available via the merchant's certification page whose details are stored in the merchant database.

In addition to consumer protection, the system and methods provide tools that allow the Internet community to identify, locate and communicate with non-virtual or traditional business entities. Recent markup language tagging and Internet search capabilities now allow pages bearing a certification seal from the certification network of the present invention (which are backed by our unique trustworthy and verifiable approach) to be programmatically found. Specifically, Internet search engines can be adapted to select only those sites with pages bearing a valid certification seal. This means that for the first time, traditional business as they have been previously known to the public are now identifiable on the Internet for commerce in their own certifiable category.

The merchant's unique identifier, typically in the form of a unique alpha-numeric string, identifies that business in a way that no other publicly and readily available merchant identification mechanism does. Once assigned, the number does not change and it is posted prominently before the public at the merchant's Web site or other online representation of his business.

In such preferred additional embodiments of the invention, various entities are expected to key in on merchants' unique identifiers programmatically across the Internet. With the capability of traversing the world's largest computer network, namely the Internet, the verifiable certification seals provided by systems and methods of the present invention greatly facilitate B2B e-commerce initiatives by allowing the Internet to segregate its traditional merchant business entities effectively from the population at large. The present invention provides businesses and organizations with a third party verified and up to date central database containing the vital information of traditional businesses that have a commercial presence on the Internet. A given merchant's unique identifier can thereby serve as a key relational field that can relate B2B databases together across the Internet. Further, B2B companies may be given permission to write factory authorizations directly to the merchant's record, etc., thereby greatly facilitating B2B efforts on a large scale.

When used in conjunction with business telephone listings, the combination of the merchant database of the certification network and the unique identifier provided by the certification process of the present invention allows the Yellow Pages (both traditional book and electronic versions) to serve as a mechanism for locating brick-and-mortar merchants in a particular category that have a certified web presence. In fact, according to the present invention, traditional Yellow Pages listings can be made to surpass Internet search engines in the ability to locate online credentials and offerings of regional merchants. To accomplish this, the certified merchant merely requests that its certification seal and/or unique identifier appear next to its Yellow Pages listing (or, less preferably, within a Yellow Pages advertisement).

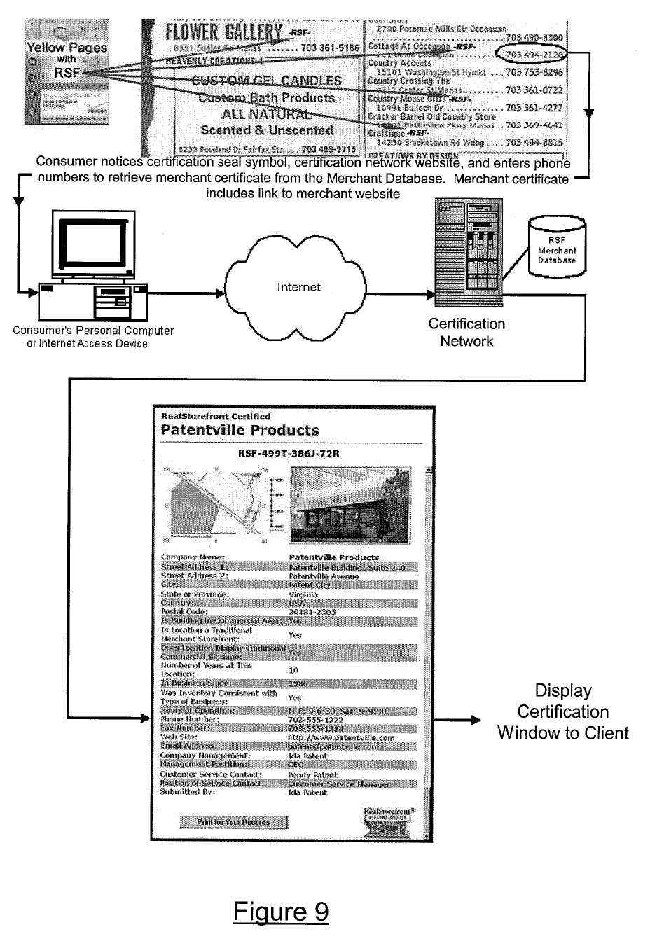

A consumer wishing to learn more about a particular certified merchant does not need to know the Internet URL to locate the merchant on the Internet. The merchant's information, including the merchant's Internet URL, can be found by visiting the certification network's Web site and locating the merchant in directly from the merchant database by keying in its telephone number, name, etc. as it appears in the Yellow Pages. Upon the successful return of that query, the consumer will be presented with the merchant's certification record window for the certified merchant (such as, for example, is depicted in FIG. 8). It should be noted, however, that the merchant database of the present invention will retain old information (such as prior addresses, URLs or phone numbers of certified merchants) such that the web site supported by the certification network of the present invention can support searches for merchants based upon, for example, old phone numbers. This Yellow Pages initiated lookup aspect of the invention is illustrated self-explanatorily in FIG. 9.

Similarly, one skilled in the art will readily appreciate that a merchant's web site address (URL) may change from time to time for a variety of reasons including that the merchant may have purposely changed domain names, or it may have changed Internet Service Providers or online mall locations thus requiring a URL change. Unfortunately, Internet search engines will still attempt to locate a merchant's site by the now defunct URL. The consequential dead links returned by the engines are costly to the merchant and the search engine companies, as well as the Internet at large. According to other additional preferred embodiments of the present invention, a certified merchant is contractually obligated (as a condition of its continued certification), as well as being motivated by profit, to keep his web address (URL) current in the merchant database of the certification network. For search engines supporting the ability to limit search results to certified merchant sites, the search engine site submission form will provide an additional field for a merchant's unique identifier of certification.

Upon receipt of a URL request that produces a dead link, the search engine will check its field for that site. If it contains a merchant's unique identifier, the engine will redirect itself to query merchant database and obtain the new URL for the certified merchant. Additionally, in operation whenever the merchant's URL is updated from the merchant database could be found in the database, a flag will be entered causing an administrator to check to see whether the merchant has modified his web address and has asked the engines to repair his dead links. In this manner, failures of certified merchants to update their URL data can be recognized and appropriately remedied. Supplied with the proper URL address, the search engine strips the old web root address from its initial query, replaces it with the merchants' new web address and returns a valid page to the user instead of a “Page cannot be found” message. The search engine then permanently modifies its records with the merchant's new address, thereby greatly improving its accuracy and avoiding the continued delivery of dead links.

Further, the combination of the verifiable and third party controlled merchant database and the unique identifier of the present invention may also be used to screen for security protocol breaches during the exchange of confidential information (such as credit card numbers). Rather than submit confidential information directly to a site that may or may not employ the use of a secured protocol and security certificate, consumer data is directed to certification network servers via a secure protocol and held temporarily. The certification network then spawns a security checking process that runs ahead of the transaction, so to speak, to examine the security certificate information on the merchant's web server. The security checking process will thereby determine whether adequate protection is in place at the merchant server before confidential information is transmitted. If it is the, consumer's data is then transmitted. Otherwise, the transaction is stopped and the consumer is alerted. In this manner, the present invention can be adapted advantageously in yet other preferred embodiments to provide even further increased security on behalf of Web consumers.

Furthermore, in other additional alternative embodiments the combination of the merchant database of the certification network and the unique identifier provided by the certification process of the present invention can facilitate the manner in which consumers bookmark a certified merchant's web site URL. Understandably, when consumers buy online, they want to record certain information that will allow them to contact the merchant in the future. They may need customer support, for example, or are possibly contemplating purchasing again from that vendor, etc. Typically, consumers have recorded this information in Address books, card files, rolodexes and even browser “bookmarks: and browser “favorites.” However, a major disadvantage to those resources is that they are only reliable as long as the information doesn't change. For example, an address book does not change itself to reflect a merchant's new phone number when his area code changes. More relevantly, a browser bookmark or favorite records a web address (“URL”), but that address frequently gets changed and the link no longer works.

The unique identifier assigned to each certified merchant according to the present invention can facilitate a reliable, constantly updating, dynamic index of merchant information. Specifically, when purchasing from a certified merchant, or reviewing the record of a certified merchant at the web site hosted by the certification network, consumers can bookmark to the merchant's record in the merchant database that, so long as the merchant complies with its certification obligations, will always contain the most current information for that merchant. This is true regardless of whether his phone number or web address changes.

The certification network's merchant database and unique merchant identifier also provides a simple and convenient way for vendor certifications to be provided. For manufacturing companies (vendors) that use unrestricted distribution systems to sell their products to end consumers, large wholesale distribution companies (distributors) are used to supply retail businesses (merchants/resellers) with their products.

Certain vendors, however, employ restricted distribution systems to get their products to consumers. In such systems, merchants request products from the distributors but vendors frequently authorize only certain merchants to sell restricted portions of their product lines. Since distributors are responsible for providing resellers with product, they need to know which merchants are authorized to sell which restricted merchandise from which manufacturers.

Typically, in restricted distribution systems as described above, distributors must keep track of which merchants are authorized by which vendors, as they can sell restricted merchandise only to authorized merchants. Typically, determining which merchants are authorized by which vendors for which products is a complicated process that involves the merchant first contacting the vendor to confirm authorization. If the vendor approves, the merchant must then contact each distributor to give them the authorization information. The merchant, all of the distributors, and the vendor all need to keep track of this information, and some distributors will be current with the merchant's authorization and others will not, depending on whether the merchant has contacted them yet with the new information.

As will be appreciated, use of the unique identifier and secure and verifiable trusted third party merchant database according to the present invention enables vendors to identify authorized merchants to its distributors via the unique identifier. Such a mechanism is attractive to vendors because they can post their application forms online electronically and bypass the need to directly involve the distributors in the authorization process. Understandably, this aspect has many administrative advantages. Vendors can see the merchant's verified certificate, thereby knowing they have a storefront building to display their merchandise, the number of years in business, etc. Additionally, they can also search a universal vendor authorizations database (an adaptation of the merchant database) via a query of which merchants are authorized by competitors. They then can authorize those merchants automatically and target them for a mutual increase in business.

If vendor authorization data is stored in a certified merchant's database record in the certification network as described in this additional alternative embodiment, distributors can simply point their databases to the vendor authorization database when a merchant requests a product requiring authorization. As with the other alternative embodiments as described above, they only need the merchant's unique identifier to know exactly how a certified merchant is authorized by participating vendors. Merchants presently may buy from one distributor versus another because they haven't submitted their info with the other yet and they don't have time. Utilization of the present invention as thus described removes these obstacles and keeps all distributors current and frees their staff for other things while still allowing merchant's to take advantage of fluctuations in price from distributor to distributor.

The foregoing description, examples and figures pertain merely to preferred embodiments that are intended to illustrate the principles of the present invention. Those skilled in the art will be able to devise numerous arrangements, which, although not explicitly depicted or described herein, nevertheless, employ principles that are within the spirit and scope of the invention.

Therefore, various modifications of the embodiments herein disclosed will be readily apparent to one skilled in the art after reading the above. Any and all such modifications are intended to be covered by the application as claimed.

What is claimed is:

1. A method for identifying the electronic commerce Internet efforts of traditional merchant businesses using a trusted third party certification network, said method comprising:
receiving requests from merchants for certification as a traditional merchant business, said requests being received at said certification network, and said certification network providing electronically verifiable certification regarding each merchant that qualifies as being a traditional merchant business;
initiating a background check of each merchant requesting certification, said background check qualifying a given merchant for certification if said merchant is determined according to predetermined criteria to conduct similar merchant business in a non-virtual and traditional commercial setting wherein said background check includes an on-site survey of said traditional commercial setting by a representative of said certification network; and
assigning a unique identifier to each certified merchant and storing an electronically verifiable record of each said merchant certification at said certification network, each said record being publicly accessible using an appropriate unique identifier.

2. The method according to claim 1, wherein said requests for certification include an agreement by each merchant to undertake ongoing obligations to keep said record up to date.

3. The method according to claim 2, wherein said ongoing obligations of each said certified merchant includes an agreement with said certification network to submit to regular repeat on-site surveys of said traditional commercial setting merchant by said representative in order to maintain said certification.

4. The method according to claim 1, wherein said predetermined criteria include indications of activity as a traditional merchant selected from the group consisting of a store front, commercial signage, on-site inventory and presence of in-person interaction between sales staff and consumers.

5. The method according to claim 1, wherein said certification network is electronically connected to the Internet and supports a certification network web site, said certification network web site providing consumers with the ability to verify the certification claims of particular Internet merchants by consulting relevant portions of said records.

6. The method according to claim 5, wherein said certification network web site is electronically accessible by the public to search for information regarding certified merchants.

7. The method according to claim 6, wherein said information regarding certified merchants includes the current web addresses for e-commerce web sites of said certified merchants.

8. The method according to claim 7, wherein said e-commerce web addresses can be obtained by bookmarking appropriate web addresses for a certification page containing relevant portions of said records.

9. The method according to claim 7, wherein said e-commerce web addresses can be obtained from said certification network web site by searching according to merchant phone number.

10. The method according to claim 1, wherein each said certified merchant is provided with a certification seal containing said unique identifier.

11. The method according to claim 10, wherein said certification seal of a given certified merchant is adapted to be visibly placed on pages of a web site of said given certified merchant, and wherein said certification seal provides click-through verification of said certification seal by said certification network.

12. The method according to claim 11, wherein clicking on said certification seal by a consumer visiting said web site causes the launching of a verification window containing certification information regarding said given certified merchant, and said information being obtained electronically in real time from said given certified merchant's current record in said certification network.

13. The method according to claim 10, wherein said certification seal comprises a digital image having said unique identifier incorporated therein.

14. The method according to claim 1, wherein said record of a given certified merchant contains information selected from the group consisting of said unique identifier, store address, a map showing said store address, web site URL, return policy, privacy policy, and phone numbers.

15. An electronic system for segregating the electronic commerce Internet efforts of traditional merchant businesses from Internet-only enterprises, said method comprising:
a trusted third party certification network, said network comprising a merchant database, and computing means;
a communication link providing electronic communication to and from said certification network via the Internet; and
wherein said computing means has software routines encoded thereon to enable merchants that are deemed to have met a predetermined set of criteria representative of physical location, permanence, business practices and overall consumer trustworthiness to be certified in said merchant database, and wherein said certification according to said predetermined set of criteria is dependent upon results of an on-site field survey at each merchant's traditional place of business.

16. The system according to claim 15, wherein said computing means further has software routines encoded thereon to enable a certification network web site, said certification network web site being accessible by consumers via the Internet and providing consumers with the ability to verify the certification claims of particular Internet merchants by consulting certification records in said merchant database.

17. The system according to claim 15, wherein said computing means further has software routines encoded thereon to assign a unique identifier to each certified merchant and store an electronically verifiable record of each said merchant certification in said merchant database, each said record being publicly accessible using an appropriate unique identifier.

18. The system according to claim 17, wherein said computing means further has software routines encoded thereon to enable certified merchants to electronically link to their respective verifiable record over the Internet'from their web site.

19. The system according to claim 15, wherein said link is enabled by a certification seal adapted to be visibly located on each said certified merchant's web site, wherein said certification seal comprises a digital image having a unique identifier of the particular merchant incorporated therein.

20. The system according to claim 15, wherein said wherein said predetermined set of criteria include indications of activity as a traditional merchant selected from the group consisting of a store front, commercial signage, on-site inventory and presence of in-person interaction between sales staff and consumers.
